(19) United States
(12) Patent Application Publication
(10) Pub. No.: US 2022/0233040 A1
(43) Pub. Date: Jul. 28, 2022

(54) Dual Function Robotic Cleaning Device

(71) Applicants: Xiwang Qi, Scottsdale, AZ (US); Mei Jiang, Scottsdale, AZ (US)

(72) Inventors: Xiwang Qi, Scottsdale, AZ (US); Mei Jiang, Scottsdale, AZ (US)

(21) Appl. No.: 17/158,416

(22) Filed: Jan. 26, 2021

(51) Int. Cl. A47L 9/12; A47L 9/00; A47L 9/28

(52) U.S. Cl. CPC A47L 9/12; A47L 9/009; B25J 11/0085; A47L 9/2894; A47L 9/2805

(57) ABSTRACT

Described is related to a dual function robotic cleaning device for removing harmful chemical pollutants, viruses, unpleasant odors as well as particulates from indoor air in addition to cleaning dust and debris from the ground or floors. The device has a floor cleaning unit and an indoor air purification unit integrated in the same body which can operate automatically according to indoor air pollution levels as well as by a user's instructions. The air purification unit consists of a virus zapping filter for eliminating airborne viruses, a chemical and odor filter for removing toxic chemical pollutants and unpleasant odors, a particulate filter for trapping PM2.5, and a chemical sensor for detecting chemical pollutant levels in indoor air, which feeds pollution values to the control unit of the device to trigger the air cleaning operation.

### CROSS-REFERENCE TO RELATED APPLICATION

This application claims priority of Provisional Application Ser. No. 62/968,518 filed in the United States Patent and Trademark Office on Jan. 31, 2020, and which addresses the same subject matter.

### FIELD OF THE INVENTION

This invention is related to a robotic cleaning device which has integrated dual functions of indoor air purification for viruses including COVID-19, toxic chemical pollutants, including carcinogenic formaldehyde and benzene, carbon monoxide, nitrogen dioxide, volatile organic compounds, as well as unpleasant odors and PM2.5, in addition to cleaning dust and debris off floors.

### BACKGROUND OF THE INVENTION

Robot cleaning devices have been on the market for some years with the purpose of cleaning a floor by sucking the debris and dust off the ground while traveling automatically over spaces. Over the past decades, more and more synthetic materials and chemical products are used in homes and other living spaces, and various toxic chemicals are emitted from interiors, paints, furniture, carpet, foam insulation, adhesives, sprays, disinfectants, cleaners, pesticides, as well as from cooking and fireplace fumes. As a result, the indoor air of homes and buildings are increasingly subject to harmful chemical pollutants such as formaldehyde, benzene, carbon monoxide, nitrogen oxides, ammonia, sulfur dioxide, hydrogen sulfide, chlorine, butadiene, toluene, xylene, etc. These chemicals can easily accumulate to higher concentrations in indoor air and cause permanent damage to the lungs, liver, heart, brain and other organs as people breathe in contaminated air over time. Children, pregnant women, and the elderly are especially vulnerable because of their weaker immune systems. For example, benzene, a known cause of leukemia, is often found in fuel fumes and new carpets, while formaldehyde, classified as a human carcinogen by the International Agency for Research on Cancer, is often found in cigarette smoke, insulation foam, and pressed wood furniture. According to the World Health Organization (WHO), 3.8 million deaths per year are attributed to household air pollution worldwide. In addition, airborne viruses such as COVID-19 have made indoor air even more deadly and have forced thousands of businesses, restaurants, and schools to close.

### DESCRIPTION OF THE PRIOR ART

Robot cleaning devices on the market such as Roomba and RoboVac are only capable of picking up dust and debris on the floor. U.S. Pat. No. 8,496,737 describes a movable air purification robot system. U.S. Pat. No. 9,770,149 describes a robot cleaner with a dust sensing apparatus. U.S. Pat. No. 10,427,085 describes a cleaning robot with an interchangeable dust collecting box or an air cleaning box. These cleaning robots in the prior arts mainly target cleaning floating particles and dust from the air and are incapable of dealing with airborne viruses such as COVID-19, which is an extremely tiny particle with a diameter of about 0.1 micrometers, or 1/700 of the thickness of a human hair. Chemical air pollutants are of an even smaller size, present as single molecules in the air that are 100 times smaller than COVID-19. The main reason that chemical pollutants and viruses are not targeted in prior arts is because of the limitation of current air filter technology to effectively handle airborne particles smaller than 0.1 micrometers or smaller. Therefore, a cleaning robot with an integrated airborne virus and chemical removal function will be ideal for households and businesses to clean both the floor and the indoor air which is often subject to deadly viruses and chemical pollutants.

### BRIEF SUMMARY OF THE INVENTION

This invention is related to a robotic cleaning device for removing harmful chemical pollutants, viruses, unpleasant odors and PM2.5 from indoor air alongside its standard function of cleaning floors, The device comprises: 1) a round main body with two motor-driven wheels and a passive 360-degree rotating wheel installed underneath which enables the movement around the floor with pre-set algorithms; 2) a floor cleaning unit with a suction port and a dust collection chamber; 3) an indoor air purification unit which includes: a) a virus zapping filter for eliminating airborne viruses; b) a chemical and odor filter for removing toxic chemical pollutants and unpleasant odors; c) a particulate filter for trapping PM2.5; 4) an indoor air inlet and a clean air outlet which has openings on the lateral side and on the top of the main body respectively; 5) a suction motor for drawing in air from the suction port on the bottom as well as from the indoor air inlet on the lateral side, and for blowing the purified air out through the clean air outlet on the top; 6) a chemical sensor for detecting chemical pollutant levels of the surrounding air; 7) a control unit which controls the robot's movement patterns based on pre-set algorithms with chemical sensor input; 8) a rechargeable lithium ion battery with a charging port.

### DETAILED DESCRIPTION OF THE INVENTION

This invention is related to a robotic cleaning device that possesses dual functions: a) automatic indoor air purification for removing harmful chemical pollutants, viruses including COVID-19, unpleasant odors and PM2.5; b) automatic floor cleaning via suction of debris and dust from floors and carpets. The dual function device can provide customers significant protection against indoor air pollution as well as deadly airborne viruses while keeping floors and carpets clean.

The said robotic cleaning device is a round and frisbee-shaped device with two motor-driven wheels and a passive 360-degree rotating wheel installed underneath which enable floor movement with pre-set algorithms. The device has two distinct functional units integrated into the main body. First is the indoor air purification unit, which includes an indoor air inlet with grille openings on the lateral side, a clean air outlet with grille openings on the top, and an indoor air filter assembly, consisting of a virus zapping filter for trapping and killing airborne viruses, a chemical and odor filter for trapping and eliminating toxic chemical pollutants and unpleasant odors, and a particulate filter for trapping PM2.5. Second is the floor cleaning unit, which has a suction port underneath for sucking dust and debris from floors and carpets, and a dust collection chamber inside the main body to store the collected debris and dust. The device has a shared suction motor for drawing in air from both the suction port on the bottom during floor cleaning and from the indoor air inlet on the lateral side. The air flow out of the dust collection chamber will merge with the air flow from the indoor air inlet and pass through the indoor air purification filter assembly to allow the purified air to flow out of the clean air outlet on the top.

A chemical sensor is installed near the indoor air inlet for detecting the chemical pollutant level of indoor air. The device also has an obstacle sensor for determining distance to obstacles in the room like furniture or walls to avoid collisions. A control unit equipped in the device, which receives data from chemical and obstacle sensors as well as instructions from users' smartphones which communicate with the device via Wi-Fi, directs the robot's movement patterns, i.e., floor cleaning pattern or air purification pattern. When the detected chemical pollutant concentration is higher than the pre-set safe limit value, the robot will automatically start the suction motor and station at the same spot until the chemical pollutant concentration has decreased to under the safe limit. Thereafter the robot will continue to travel according to the floor cleaning pattern until the chemical sensor detects another high chemical pollutant concentration area, at which time it will station and repeat the air purification operation. The robotic cleaning device is powered by a rechargeable battery. When the battery in the device runs out, the robot will return to the charging dock to get recharged.

The virus zapping filter mentioned above consists of nano-sized antivirus agents supported on nano-structured composite materials. The chemical and odor filter mentioned above consists of nano-sized catalysts supported on nano-structured composite materials. The particulate filter mentioned above is an electrostatic filter, which can trap at least 99% of the particulates in the air which are larger than 0.3 micrometers. The nano-structured composite materials are moisture and thermal resistant and can be regenerated for reuse, thus create zero filter waste.

The nano-structured composite materials mentioned above are made and formulated to create an enormous pollutant-trapping surface area, comprise of nano-engineered porous materials which contain at least one material from the group consisting of nano-porous carbon, nano-porous rare earth oxide, nano-porous zeolite, nano-porous alumina, nano-porous silica, and nano-porous cordierite. The nano-scale integration of nano-antivirus agents with nano-structured composite materials creates powerful antimicrobial sites for trapping and destroying airborne viruses. The nano-scale integration of nano-catalysts with nano-structured composite materials creates extremely active sites for trapping and consumption of harmful chemical pollutants and unpleasant odors with their unique chemical and catalytic synergy. The nano-antivirus agents, the nano-catalysts and the nano-engineered porous composite materials of this invention are not consumed or saturated by viruses or chemical pollutants over time so the filter will maintain its efficiency for a much longer period of time versus air filters in prior art such as activated carbon filters.

The nano-antivirus agents and the nano-catalysts described above in this invention are selected from the group consisting of iron, cobalt, nickel, copper, zinc, manganese, magnesium, potassium, sodium, calcium, barium, titanium, platinum, palladium, rhodium, ruthenium, silver, cerium, and their corresponding oxides and combinations.

The rare earth oxide described above in this invention is selected from the group consisting of yttrium oxide, lanthanum oxide, cerium oxide, praseodymium oxide, samarium oxide, rare earth doped oxides including yttrium doped zirconia and cerium doped zirconia, and combinations.

The zeolite described above in this invention is selected from the group consisting of 3A zeolite, 4A zeolite, 5A zeolite, 13X zeolite, Beta zeolite, Pentasil zeolite and Mordenite zeolite, and their combinations.

The airborne viruses that can be trapped and destroyed by the device include, but are not limited to, COVID-19, flu virus, measles virus, SARS virus and other coronaviruses. The harmful chemical pollutants that can be eliminated by this invention include, but are not limited to, formaldehyde, butadiene, acetaldehyde, benzene, toluene, xylene, acetone, methylene chloride, tetrachloroethylene, phenol, polycyclic aromatic hydrocarbons, carbon monoxide, nitrogen oxides, sulfur dioxide, ozone, hydrogen sulfide, chlorine and ammonia. The unpleasant odors that can be removed by this invention include cigarette smoke, wildfire smoke, diesel and gasoline fumes, alcoholic beverages, bathroom smells, mold smells, dirty laundry odors, shoe and socks odors, rotten and burned food, paint odors, moth balls, pet, fish and poultry odors.

The dual-function robotic cleaning device of this invention can be used in many common indoor spaces including homes, offices, classrooms, hotel rooms, restaurants, locker rooms, sports venues, and conference halls.

In one embodiment of the invention, the robotic cleaning device has a size of 12 inches in diameter and 3 inches in thickness. The indoor air filter assembly, which has a size of 3 inches by 6 inches and one-inch in thickness, is a 3-layer structure consisting of a virus zapping filter, a chemical and odor filter and a particulate filter stacked together. The virus zapping filter consists of small grains of nano-structured composite materials made of nano-porous rare earth oxide, nano-porous zeolite and nano-porous alumina. The chemical and odor filter consists of small grains of nano-structured composite materials made of nano-porous carbon, nano-porous rare earth oxide, nano-porous zeolite, nano-porous alumina and nano-porous silica. The particulate filter is made of non-woven synthetic fiber and is electro-charged for optimal trapping efficiency without compromising the back pressure.

This invention having thus been shown and described is intended to be illustrative only and not limiting, and will be understood by those skilled in the art that other embodiments can be devised without departing from the sprit and scope of the invention as disclosed herein. Therefore, the scope of the invention should be determined only from the following claims.

1. A dual-function robotic cleaning device which can operate both on floor cleaning mode for dust and debris cleaning and on indoor air purification mode for removing harmful chemical pollutants, viruses, and unpleasant odors as well as particulates from the air while moving around, comprising:
a. a virus zapping filter for trapping and destroying indoor airborne viruses;
b. a chemical and odor filter for eliminating harmful indoor chemical pollutants and unpleasant odors;
c. a particulate filter for trapping PM2.5;
d. a shared suction motor for drawing in air from the suction port on the bottom and from the indoor air inlet on the lateral side;
e. a chemical sensor for detecting chemical pollutant levels of indoor air;
f. an obstacle sensor for determining distance to obstacles in the room;
g. a control unit which receives data and instructions from chemical and obstacle sensors as well as a user's smartphone via Wi-Fi and directs the robot's movement patterns across the ground;

2. The robotic cleaning device according to claim 1, wherein said indoor air purification mode can be triggered by chemical sensor input, and when the detected chemical pollutant concentration is higher than the pre-set safe limit value, the robot will automatically run on indoor air purification mode and station at the same spot until the chemical pollutant concentration has decreased to under the safe limit, at which point the robot will continue to travel thereafter according to the floor cleaning mode pattern unless the chemical sensor detects another high chemical pollutant concentration area, whereby it would station and repeat the air purification operation.

3. The robotic cleaning device according to claim 1, wherein said virus zapping filter consists of nano-sized antivirus agents supported on nano-structured composite materials.

4. The robotic cleaning device according to claim 1, wherein said chemical and odor filter consists of nano-sized catalysts supported on nano-structured composite materials.

5. The virus zapping filter according to claim 3, wherein said nano-structured composite materials comprise nano-engineered porous substrate materials which contain at least one material selected from the group consisting of nano-porous carbon, nano-porous rare earth oxide, nano-porous zeolite, nano-porous alumina, nano-porous silica and nano-porous cordierite.

6. The chemical and odor filter according to claim 4, wherein said nano-structured composite materials comprise nano-engineered porous substrate materials which contain at least one material selected from the group consisting of nano-porous carbon, nano-porous rare earth oxide, nano-porous zeolite, nano-porous alumina, nano-porous silica and nano-porous cordierite.

7. The virus zapping filter according to claim 3, wherein said nano-structured composite materials can be in the form of grains, pellets, or thin slices of honeycomb monolith.

8. The chemical and odor filter according to claim 4, wherein said nano-structured composite materials can be in the form of grains, pellets, or thin slices of honeycomb monolith.

9. The virus zapping filter according to claim 3, wherein said nano-sized antivirus agents are selected from a group consisting of cobalt, nickel, copper, zinc, silver, manganese, palladium, ruthenium, their corresponding oxides, and combinations thereof.

10. The chemical and odor filter according to claim 4, wherein said nano-catalysts are selected from a group consisting of iron, cobalt, nickel, copper, zinc, silver, manganese, sodium, potassium, titanium, platinum, palladium, rhodium, ruthenium, cerium, their corresponding oxides, and combinations thereof.

11. The virus zapping filter according to claim 5, wherein said rare earth oxide is selected from a group consisting of yttrium oxide, lanthanum oxide, cerium oxide, praseodymium oxide, samarium oxide, and rare earth doped oxides including yttria-zirconia and ceria-zirconia, and combinations thereof.

12. The virus zapping filter according to claim 5, wherein said zeolite is selected from the group consisting of 3A zeolite, 4A zeolite, 5A zeolite, 13X zeolite, Beta zeolite, Pentasil zeolite and Mordenite zeolite, and combinations thereof.

13. The chemical and odor filter according to claim 6, wherein said rare earth oxide is selected from a group consisting of yttrium oxide, lanthanum oxide, cerium oxide, praseodymium oxide, samarium oxide, and rare earth doped oxides including yttria-zirconia and ceria-zirconia, and combinations thereof.

14. The chemical and odor filter according to claim 6, wherein said zeolite is selected from the group consisting of 3A zeolite, 4A zeolite, 5A zeolite, 13X zeolite, Beta zeolite, Pentasil zeolite and Mordenite zeolite, and combinations thereof.

15. The robotic cleaning device according to claim 1, wherein said harmful chemical pollutants include formaldehyde, acetaldehyde, butadiene, acetone, benzene, phenol, toluene, xylene, methylene chloride, tetrachloroethylene, polycyclic aromatic hydrocarbons, carbon monoxide, nitric oxide, nitrogen dioxide, sulfur dioxide, ozone, hydrogen sulfide, chlorine and ammonia.

16. The robotic cleaning device according to claim 1, wherein said unpleasant odors include cigarette smoke, wildfire smoke, diesel and gasoline fumes, alcoholic beverages, body odors, perfumes, bathroom odors, mold odors, dirty laundry odors, odors from shoes and socks, odors from rotten and burned food, paint odors, moth balls, pet odors, fish odors, and poultry odors.

17. The robotic cleaning device according to claim 1, wherein said viruses include COVID-19, flu virus, measles virus, SARS virus and other coronaviruses.
